(19) United States
(12) Patent Application Publication
(10) Pub. No.: US 2023/0374811 A1
(43) Pub. Date: Nov. 23, 2023

(54) DAMPING MECHANISM

(71) Applicant: University of Virginia Patent Foundation, Charlottesville, VA (US)

(72) Inventors: Osman E. Ozbulut, Charlottesville, VA (US); Amedebrhan Asfaw, Waynesboro, VA (US)

(21) Appl. No.: 18/247,179

(22) PCT Filed: Oct. 1, 2021
(86) PCT No.: PCT/US2021/071680

§ 371 Date: Mar. 29, 2023

Related U.S. Application Data
(60) Provisional application No. 63/086,651, filed on Oct. 2, 2020.

(51) Int. Cl. E04H 9/02; F16F 7/08; F16F 7/12

(52) U.S. Cl. CPC E04H 9/0237; F16F 7/08; F16F 7/12; F16F 2222/04; F16F 2236/06; F16F 2236/04; F16F 2224/0258

(57) ABSTRACT

A damping mechanism for damping energy resulting from a lateral force on a structure may include a first portion, a second portion configured for longitudinal motion relative to the first portion, a primary energy absorption system configured for frictionally coupling the first portion and the second portion and converting motion of the second portion relative to the first portion into heat energy, and a secondary energy absorption system configured to absorb energy through non-linear deformation and provide a self-centering effect on the damping mechanism.

### CROSS-REFERENCE TO RELATED APPLICATIONS

The present application claims priority to U.S. Provisional Application No. 63/086,651 filed on Oct. 2, 2020 and entitled System and Method for Superelastic Friction Dampers and Seismic Response Mitigation, the content of which is hereby incorporated by reference herein in its entirety.

### TECHNICAL FIELD

The present application relates generally to systems and device for energy absorption. More particularly, the present application relates to lateral force resisting systems and components thereof for resisting and/or absorbing lateral forces on buildings or other structures. Still more particularly, the present application relates to seismic force resisting and energy absorption systems for buildings including non-essential buildings.

### BACKGROUND

Buildings and other structures are commonly designed to resist lateral forces such as wind and seismic loads in addition to gravity-based loads such as dead load and live load. Depending on the location of the structure, different design criteria may be imposed by state and local officials through the application of one or more building codes. In many cases, the different design criteria may come in the form of different design loads. For example, buildings located near the coast may be subject to higher wind design loads and buildings located in areas more prone to earthquakes may be subject to higher seismic design loads.

However, in addition to building location, the building purpose, or occupancy, and other factors may also play a role in establishing design criteria. That is, for example, the international building code includes a table of risk categories I-IV that are based on the occupancy of the building. The building code then uses an importance factor based on the risk category that increases or decreases the design loads based on the respective risk category. As may be appreciated, sophisticated damping systems may be provided for relatively high risk buildings such as hospitals or other large buildings with high occupancy. In some cases, the damping systems themselves may be replaced, reset, or other intervention may be provided after a seismic event. Given the importance of the structures and in some cases the revenue being generated by the structures, this cost may be sustainable. However, for lower risk buildings, these sophisticated damping systems and the expense of intervention after a seismic event may be less sustainable. Nonetheless, earthquakes can still cause a lot of property damage for lower risk buildings or structures.

### BRIEF DESCRIPTION OF THE DRAWINGS

FIG. 1 is a perspective view of a structure having a lateral force resisting system with a damping mechanism, according to one or more examples.

FIG. 2 is a side view of the damping mechanism of FIG. 1.

FIG. 3 is a cross sectional view thereof.

FIG. 4 is an additional cross sectional view thereof.

FIG. 5 is a top down view thereof.

FIG. 6 is an exploded view thereof.

FIG. 7A is a diagram of the damping mechanism in a neutral position, according to one or more examples.

FIG. 7B is a diagram of the damping mechanism under a tensile load and showing the tensile force in the ties, according to one or more examples.

FIG. 7C is a diagram of the damping mechanism under a compressive load and showing the tensile forces in the ties, according to one or more examples.

FIG. 8 is a perspective view of a tie of the damping mechanism of FIGS. 2-7C, according to one or more examples.

FIG. 9 is a perspective view of another example of a damping mechanism according to one or more embodiments.

FIG. 10 is a side view thereof.

FIG. 11A is a hysteresis graph of motion of the damping mechanism at a frequency of 0.05 Hz, according to one or more examples.

FIG. 11B is a hysteresis graph of motion of the damping mechanism at a frequency of 0.1 Hz, according to one or more examples.

FIG. 11C is a hysteresis graph of motion of the damping mechanism at a frequency of 0.5 Hz, according to one or more examples.

FIG. 11D is a hysteresis graph of motion of the damping mechanism at a frequency of 1 Hz, according to one or more examples.

FIG. 11E is a hysteresis graph of motion of the damping mechanism showing all frequencies of 0.05, 0.1, 0.5, and 1 Hz, according to one or more examples.

FIG. 12A is a hysteresis graph of motion of the damping mechanism in a quasistatic condition, according to one or more examples.

FIG. 12B is a hysteresis graph of motion of the damping mechanism at a frequency of 0.05 Hz, according to one or more examples.

FIG. 12C is a hysteresis graph of motion of the damping mechanism at a frequency of 0.1 Hz, according to one or more examples.

FIG. 12D is a hysteresis graph of motion of the damping mechanism at a frequency of 0.5 Hz, according to one or more examples.

FIG. 12E is a hysteresis graph of motion of the damping mechanism at a frequency of 1 Hz, according to one or more examples.

FIG. 12F is a hysteresis graph of motion of the damping mechanism showing all frequencies of 0.05, 0.1, 0.5, and 1 Hz, according to one or more examples.

### DETAILED DESCRIPTION

The present application, in one or more embodiments, relates to lateral force resisting systems and, in particular, damping mechanisms for those systems. The damping mechanism may be adapted to not only resist lateral forces, but to also absorb energy during motion of the system. Moreover, the damping mechanism may have a self-centering mechanism that helps to both absorb energy and return the structural system to a centered position after a lateral force response. In one example, the self-centering mechanism may include a super elastic alloy that may suffer non-linear deformation during loading and may return to its preloaded shape when the load diminishes. The damping mechanism may, thus, have a very high ability to absorb loads on a repeating basis while continuing to return to its preloaded shape allowing structures to be continually resistant to lateral forces and, in particular, seismic forces without repair, reset, and/or retrofit of the damping mechanism after a lateral force event.

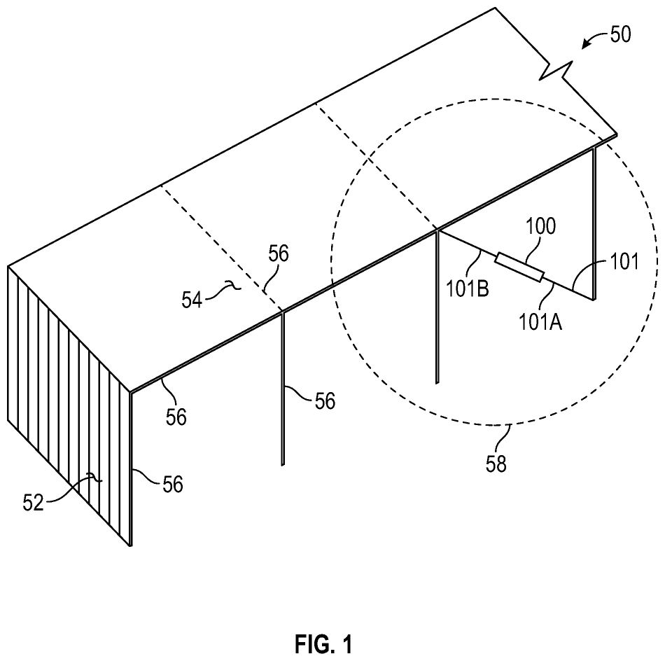

FIG. 1 is a perspective view of a structure 50 having a lateral force resisting system with a damping mechanism 100, according to one or more examples. The structure may be configured to support gravity loads on a floor or roof structure and may also be configured to resist lateral loads applied to the structure. From a lateral force resisting perspective, and as shown, the structure may include walls or exterior cladding 52, a diaphragm 54, a frame or other gravity load support structure 56, and a lateral force resisting structure 58.

The walls or exterior cladding 52 may be configured to enclose the structure 50 and protect the interior of the structure from environmental conditions. From a lateral load perspective, the walls or exterior cladding 52 may generally be the first portion of the structure to encounter lateral loading such as wind loads. The cladding 52 may be configured to span, generally vertically, between one level of the structure 50 and a next level above and, as such, deliver lateral pressures on the cladding 52 to the floor or roof structures above and below the cladding 52 in the form of a line load. The cladding 52 may take one or more of a wide variety of forms including, steel or wood studs, curtain wall such as panels of windows and spandrel glass, masonry block or brick, or other types of cladding.

The diaphragm 54 may be configured to support dead and live gravity loads by spanning between members of the frame 56. From a lateral load perspective, and in the case of wind loading, for example, the diaphragm 54 may be configured to receive the lateral line loads from the cladding 52 and distribute the lateral line loads to the frame 56 in the form of linear line loads, for example. In the case, of seismic loading, while some lateral force may be generated in the cladding 52, a higher lateral force may be generated in the diaphragm 54 itself, particularly, where the diaphragm 54 is a concrete floor, for example. That is, the nature of seismic loading may involve motion of the ground, which induces sway in a structure 50 and the seismic loading may be due to the momentum that is created in the building and the structure's effort to control the sway of the structure 50. In this case, the diaphragm 54 may be configured to distribute lateral loads within the diaphragm 54 to the frame 56 in the form of linear line loads, for example. The diaphragm 54 may take one or more of a wide variety of forms including concrete floors, steel roof decks, wood roof decks, structural wood floors, or other types of diaphragms 54.

The frame 56 may be adapted to support the one or more diaphragms 54 of a structure 50 and carry the gravity loading such as dead loads and live loads. The frame 56 may also receive linear line loads from the diaphragm 54 and carry those loads to one or more lateral force resisting structures 58. The frame 56 may take one or more of a wide variety of forms including concrete beams and columns, steel beams and columns, masonry or concrete walls, or other types of frame materials.

The lateral force resisting structure 58 may be arranged along or within the frame 56. In particular, the lateral force resisting structure 58 may be configured to collect the linear line loads on the frame 56 and resist the load by resisting motion of the frame 56 in a direction of the linear line load. In one or more examples, as shown in FIG. 1, the lateral force resisting structure 58 may include a brace 101 extending diagonally between a pair of vertically extending columns of the frame 56. In one or more other examples, the lateral force resisting structure 58 may include a V-brace or a chevron or inverted V-brace may be provided. That is, a chevron brace or an inverted V-brace may include one brace that extends from a bottom of a column of the frame 56 up to a center of a beam extending from the column to an adjacent column. Another brace may extend from the center of the beam down to the bottom of the adjacent column. The beam and the two braces may form an inverted V-shape or chevron. An upright V-brace may be used as well. Still other types of braces may be provided and the brace 101 together with the columns it is arranged between and the beam extending between the tops of the columns may form a lateral force resisting structure 58 referred to as a braced frame.

As shown in FIG. 1, the lateral force resisting structure 58 may include a damping mechanism 100. As shown, the damping mechanism may be incorporated into a diagonal brace 101. Alternatively or additionally, the damping mechanism may be incorporated into a chevron or inverted V-brace, for example. That is, an inverted V-brace such as the one described may have a top side that is spaced downward from a bottom of a beam of the frame 56 and the damping mechanism may be arranged below and parallel to a beam of the frame 56 and between the beam and a top side of an inverted V-brace, for example. A downward extending arm may be provided from the beam and an upward extending arm may be provided on the inverted V-brace. The two arms may be spaced apart from one another (along the length of the beam) and the damping mechanism may be placed between the arms. Other configurations may include an inverted V-brace with a horizontal sliding connection to the beam above the brace and a damping mechanism on either or both sides of the sliding connection to the beam. In any case, lateral force energy in the beam line of the frame 56 may be transferred to the damping mechanism via the arm extending down from the beam and the arm extending up from the inverted V-brace may resist the motion of the damping mechanism. Still other arrangements of a damping mechanism may be provided such as including one in a seismic isolation system as a supplementary damper, for example. Still other approaches to incorporating the damping mechanism into the structure may be used.

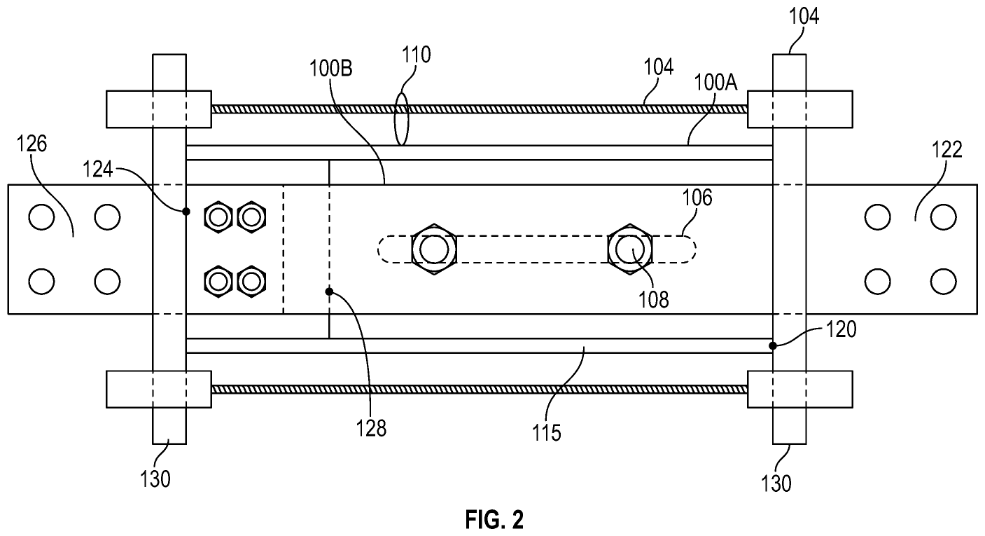

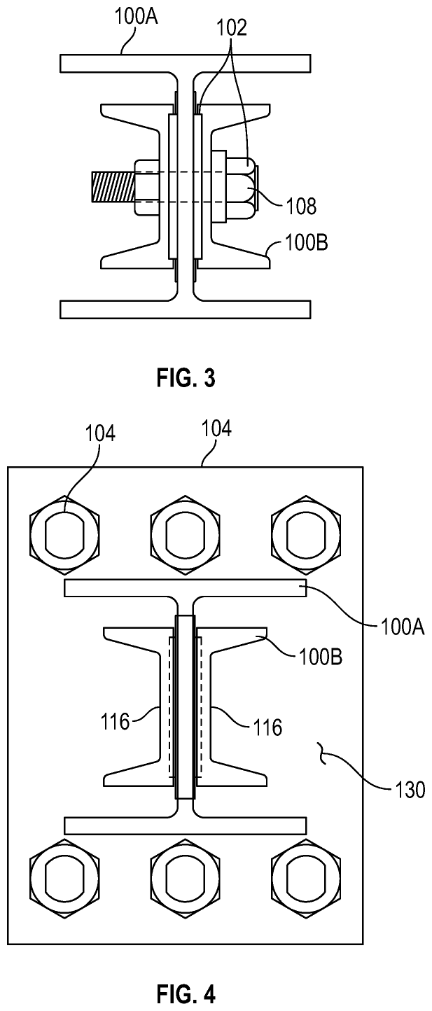

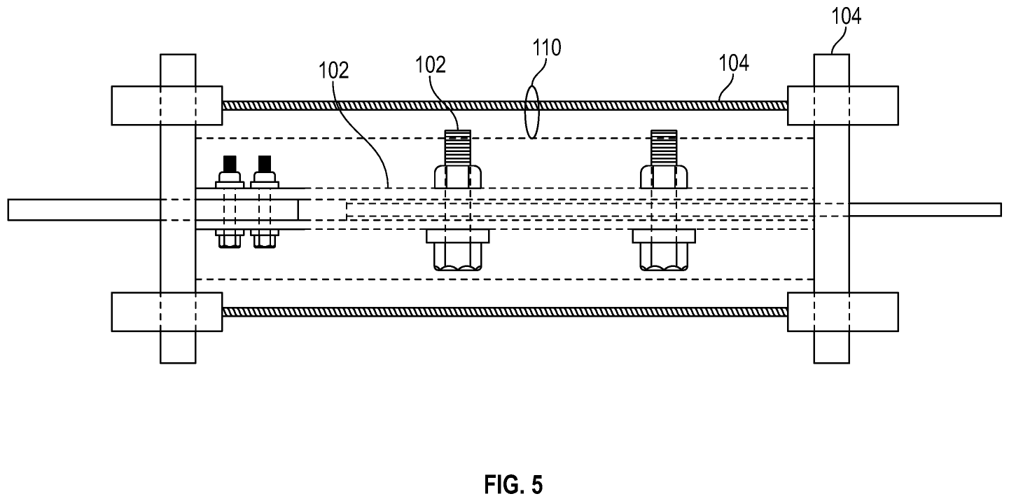

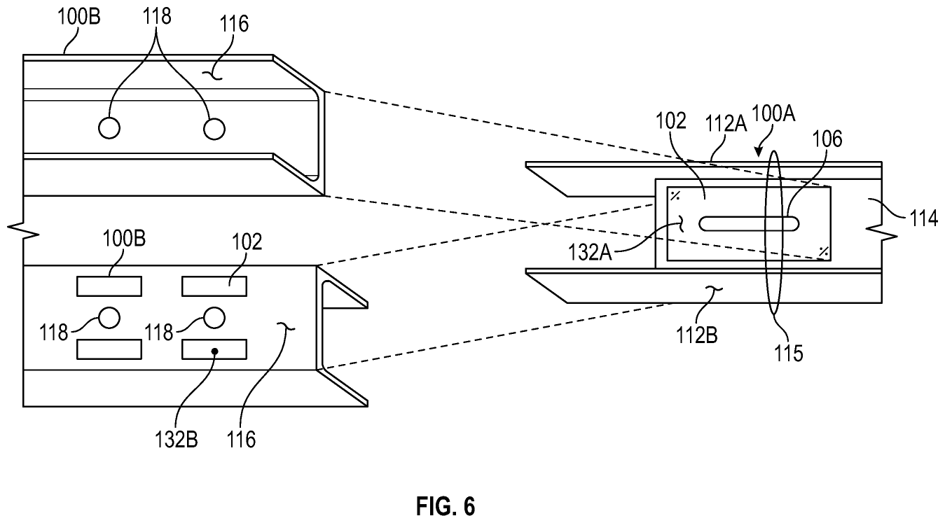

FIG. 2 is a side view of the damping mechanism 100 of FIG. 1. FIGS. 3-5 include additional views of the damping mechanism 100 and FIG. 6 shows an exploded view thereof. The damping mechanism 100 may be configured to absorb energy in the brace 101 and, as such, function to reduce the effects of lateral loading on a structure 50 and more quickly bring a swaying structure to a stop. The damping mechanism 100 may include a primary energy absorption system 102 and a secondary energy absorption system 104. The secondary absorption system 104 may also be a self-centering mechanism. Both of the primary and secondary energy absorption systems 102/104 may be incorporated into a brace 101 by way of a joint within the brace 101 that allows first and second portions 101A/101B of the brace 101 to move relative to one another. The primary and secondary energy absorption systems 102/104 may be incorporated into the joint and may function to control the relative motion between the first and second portions 101A/101B of the brace 101.

As shown, the joint may be a relative motion joint. That is, the joint may function to connect the first portion 101A of the brace 101 to the second portion 101B of the brace 101 in a manner that resists out of plane buckling of the brace 101, but primarily functions to connect the two portions of the brace while allowing relative longitudinal motion (e.g., along the length of the brace) between the first and second portions 101A/101B of the brace 101. That is, the joint may allow for telescoping like motion allowing the overall length of the brace 101 to extend or shorten depending on the loading condition. In one or more examples, the joint may include overlapping ends of the first and second portion 101A/101B where the overlapping portions are bolted together and one of the first and second portions 101A/101B includes a slotted hole 106 allowing for the relative longitudinal motion of the portions 101A/101B. While primarily functioning to establish a normal force discussed in more detail below, multiple bolts 108 may be arranged along the slotted hole 106 to prevent lateral buckling relative to an axis of the bolts 108, for example. Moreover, a sufficient amount of overlap may be provided to prevent lateral buckling relative to an axis orthogonal to the brace 101 and the bolts 108.

The primary energy absorption system 102 may include a friction-based system that converts motion into heat energy through friction. That is, the bolts 108 in the joint mentioned may be tightened to provide a selected normal force between the overlapping ends of the first and second portions 101A/101B of the brace 101. The normal force together with a coefficient of friction between the overlapping portions may allow the overlapping portions to slide relative to one another under particular loading conditions and the sliding motion together with friction between the overlapping portions may generate heat, thus absorbing the motion by converting the kinetic energy to heat energy. The secondary energy absorption system 104 may include one or more ties 110 coupled to the first and second portion 101A/101B of the brace 101. The ties 110 may be configured to stretch when the brace 101 is loaded. Moreover, the ties 110 may be of a material and size that causes them to stretch in a non-linear fashion to absorb the energy of the relative motion between the overlapping portions. The ties 101 may be composed of a shape memory alloy and, in particular, a super elastic alloy. As such, even though the ties 110 may experience a non-linear stretch, the alloys may tend to return to their preloaded shape and, as such, may function to recenter the overlapping portions of the joint.

It may be appreciated that the damping mechanism 100 may be part and parcel to the brace 101 by being incorporated into and/or being natural extensions of the first and second portions 101A/101B of the brace 101. However, the damping mechanism 100 may also be a standalone component that is secured to the first and second portions 101A/101B of the brace 101. That is, the damping mechanism 100 may be bolted, welded, or otherwise secured to free ends of the first and second portion 101A/101B of the brace 101, for example.

With this general discussion in place, the particular example of the damping mechanism 100 shown in FIGS. 2-6 with primary and secondary energy absorption systems 102/104 may be described. As shown in FIGS. 2-6, the damping mechanism 100 may establish a joint between a first and second portion 101A/101B of a brace 101. In particular, the damping mechanism 101 may include first and second portions 100A/100B adapted for securing to free ends of first and second portions 101A/101B of a brace 101. The first and second portions 100A/100B of the damping mechanism 100 may form overlapping ends of the first and second portion 101A/101B of the brace 101.

As shown in the exploded view of FIG. 6, the first portion 100A may include a beam/column or other I-shaped element 115 having an upper and lower flange 112A/B connected together with a web 114. The second portion 100B may include a pair of channels 116 sized to nest between the upper and lower flanges 112A/B of the first portion 100A and on respective sides of web 114 of the first portion 100A. As shown, the web 114 of the first portion 100A may include a longitudinally extending slotted hole 106. Each of the channels 116 may include a pair of holes 118 arranged to align with the slotted hole 106 when the channels 116 are placed on either side of the web 114. As such, a joint may be formed between the first portion 100A and the second portion 100B by placing the channels 116 on respective sides of the web 114 and placing bolts 108 through the holes 118 in the channels 116 and through the slotted hole 106 such that the channels 116 may move longitudinally relative to the I-shaped beam/column 115. It is to be appreciated that while the slotted hole 106 has been shown to be present in the web 114 of the I-shaped member 115, a slotted hole 106 may, instead be present in each of the channels 116. Still further, slotted holes 106 may be present in each of the web 114 of the I-shaped member 115 and the channels 116.

Turning back to FIGS. 2-5, the I-shaped member 115 may extend away from the joint to an outboard end 120 where the flanges 112A/B of the I-shaped member 115 and a portion of the top and bottom of the web 114 may be coped off of the member 115 and a portion of the web 114 may extend further outboard from the joint forming a tab 122. The channels 116 may extend away from the joint in the other direction to an outboard end 124 where a tab plate 126 may be placed between the pair of channels 116, which may extend further outboard from the joint. As shown, the tab plate 126 may be spaced away from the inboard end 128 of the web 114 of the I-shaped member 115 a distance sufficient to allow for the relative motion of the I-shaped member 115 and the channels 116 without encountering the channels 116. The tabs 122/126 formed on both of the outboard ends of the joint may provide for connection of the damping mechanism 100 to the first and second portions 101A/B of the brace 101.

As shown in FIGS. 2, the flanges 112A/B of the I-shaped member 115 may extend beyond the end of the web to reach the outboard end of the channels 116 when assembled as shown in FIG. 6. Also, the channels 116 may have a length that is substantially equal to the overall length of the flanges 112A/B of the I-shaped member 115. A pair of buttresses 130 may be provided at each end of the joint that abut the ends of the both the I-shaped member 115 and the channels 116 and the buttresses 130 may each include a slot in the middle to allow the tab plates 122/126 of the respective I-shaped member 115 and channels 116 to extend through the buttresses 130. The buttresses 130 may be held together and against the ends of the I-shaped member 115 and the channels 116 with a tie or ties 110.

Given the above, the primary energy absorption system 102 may be provided by the clamping of the channels 116 against the web 114 of the I-shaped member 116. That is, the bolts 108 may be torqued to provide a particular amount of tension in the bolt 108 thereby establishing a controlled normal force between the channels 116 and the side surfaces of the web 114 of the I-shaped member 115. In one or more examples, friction pads may be provided to increase the amount of friction between the first and second portions 100A/B and/or to control differences between static and kinetic friction. That is, as shown in FIG. 6, a friction pad 132A may be provided on each side of the web 114 of the I-shaped member 115. In addition, friction pads 132B may be provided above and below the holes 118 in the channels 116 on the inside surface facing the web 114 of the I-shaped member 115. When the channels 116 are bolted to the web 114 of the I-shaped member 115 the pads 132B on the channels 116 may be brought into contact with the pad 132A on the web 114 of the I-shaped member 115 creating a friction interface for controlling the relative motion of the first and second portions 100A/B of the damping mechanism 100. In one or more examples, the friction pads 132A/B may include one or more combinations of materials. For example, the pads 132A/B may include stainless steel on one side and a brake or clutch lining material (e.g., a non-metallic molded strip) on the other side. This combination of materials may establish a self-lubricating friction interface that helps to reduce a stick/slip phenomenon in the joint and may provide for a more constant coefficient of friction between the two portions of the joint. Moreover, the non-metallic material and the stainless steel material may be resistant to corrosion, thus, prolonging the life and functionality of the joint.

The secondary energy absorption system 104 may be provided by the tie or ties 110 that extend between the buttresses 130 and hold the buttresses 130 against the ends of the I-shaped member 115 and the channels 116. In particular, the ties 110 may stretch as the first and second portions 100A/B of the damping mechanism move relative to one another. In one example, the buttresses 130 may be secured to the respective I-shaped member 115 and the channels 116 and as the I-shaped member 115 and the channels 116 move apart, the buttresses 130 may move apart placing the tie or ties 110 in tension and stretching the ties 110. The stretching of the ties 110 may absorb energy from loading and supplement the primary energy absorption system 102. Moreover, and as mentioned, the ties 110 may be composed of a shape memory alloy and, in particular, a super elastic alloy. The size of the ties 110 may be selected such that the tie or ties 110 stretch in a non-linear fashion. As such, the ties 110 may avoid immediately springing back and returning the absorbed energy into the system. Rather, the non-linear elongation of the ties 110 may absorb energy. While the alloy may tend to return to its original shape, it may do so in a different manner than an elastically stretched alloy and, thus, may avoid reenergizing the system with the absorbed energy.

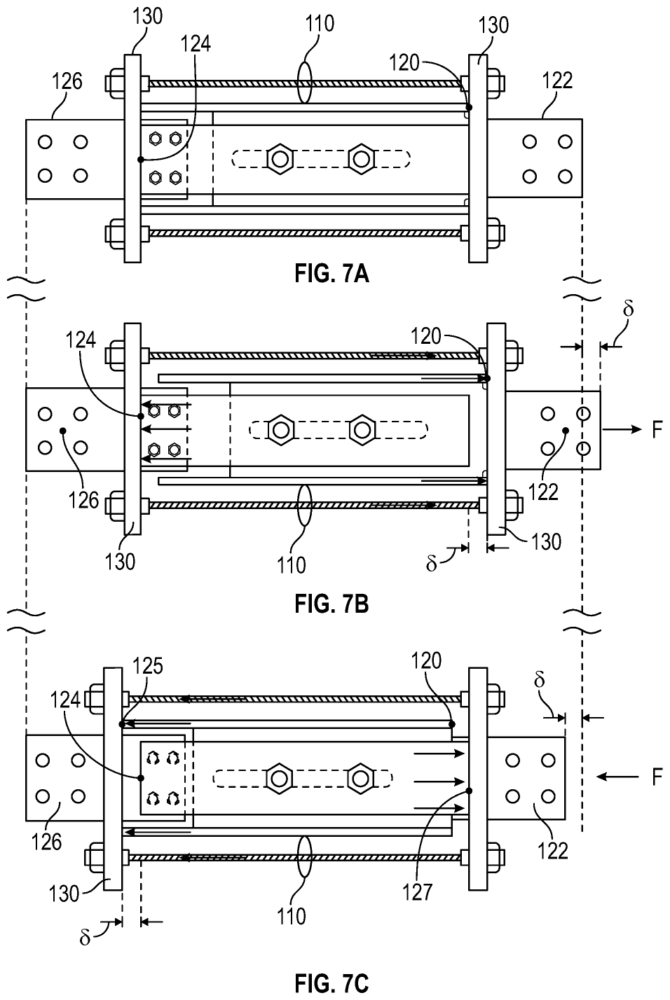

In one or more embodiments, the secondary energy absorption system 104 may include a tension inducing system. That is, while a brace 101 may be loaded in tension as described above, it may also be loaded in compression. The tension inducing system may function to place the tie or ties 110 in tension when the damping mechanism 100 or brace 101 is experiencing tension and when the damping mechanism 100 or brace 101 is experiencing tension. FIG. 7A shows the joint in a neutral condition where it is not experiencing tensile or compressive loads. As shown, the buttresses 130 may be positioned tight against the right outboard end 120 of the I-shaped member 115 and also tight against the left outboard end 124 of the channels 116. As shown in FIG. 7B, when the above-described joint is experiencing tensile loading, forces may be applied to each of the tab plates 122/126 that tend to cause the I-shaped member 115 and the channels 116 to move away from one another. In this case, the tab plates 122 may pull their respective I-shaped member 115 or channels 116 against the inboard side of the buttresses 130 drawing the buttresses 130 away from each other along with the I-shaped member 115 and channels 116, respectively, causing the ties 110 between the buttresses 130 to stretch. In contrast, and as shown in FIG. 7C, when the above-described joint is experiencing compressive loading, forces may be applied to each of the tab plates 122/126 that ted to cause the I-shaped member 115 and the channels 116 to move toward one another. In this case, the tab plates 122/126 may push their respective I-shaped member 115 or channels 116 against the buttress 130 at the opposite end 125/127 of the joint and pressing the buttresses 130 apart and causing the ties 110 between the buttresses 130 to stretch.

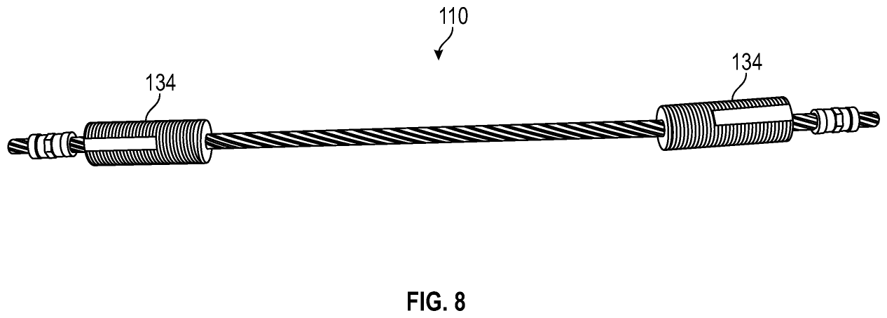

Turning now to FIG. 8, a tie 110 is shown. As shown, the tie 110 may be adapted for placement between a pair of opposing buttresses 130 and may function to absorb energy under tensile loading through non-linear deformation. The tie 110 may include threaded couplings 134 at each end allowing the ties 110 to be secured to a buttress 130 at each end and allowing for a selected amount of pre-tensioning of the system. As discussed, the tie 110 may be composed of a shape memory alloy and, in particular, a super elastic alloy such as, for example, nickel-titanium, copper-zinc-aluminum, copper-aluminum-nickel, or other super elastic alloys. In one or more embodiments, the tie 110 may be a solid bar or the tie 110 may be a cable composed of a series of strands, for example.

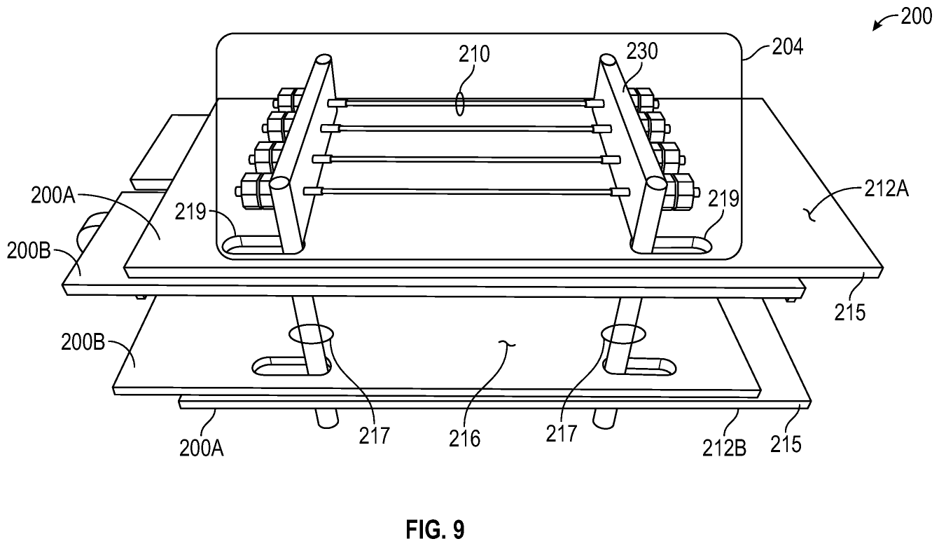

Turning now to FIGS. 8 and 9, a slightly different example of an approach to a secondary energy absorption system 204 is shown. As shown, the joint may include slightly different buttresses 230. For example, the buttresses 230 may extend across the top of the top flange 212A of the I-shaped member 215 or across the bottom of the bottom flange 212B of the I-shaped member 215. That is, and like the earlier examples, ties 210 may be provided on a top side and a bottom side of the joint and may extend from buttresses 230 near opposing ends of the joint. The buttresses 230 may be coupled to the first and second portions 200A/200B of the joint in a manner allowing for stretching of the ties 210 to supplement the frictional resistance provided by the primary energy absorption system. That is, for example, a buttress 230 at one end of the joint may be coupled to move with the first portion 200A and a buttress 230 at another end of the joint may be coupled to remain stationary relative to the first portion 200A. As such, when the first portion moves away from the second portion 200B, the distance between the buttress 230 on the first portion (which moves) and the opposing buttress 230 (which doesn't move) may increase thereby causing the ties 210 to stretch and supplement the resistance provided by the friction between the first and second portions 200A/B.

In this example, the buttresses 230 may include generally flat bars extending laterally across the flanges 212/AB of the I-shaped member 215. Other buttress shapes may also be provided such as L-shaped angles, channels, or other cross-sectional shapes. The buttresses 230 may be secured to the joint with bolts, bars, or other connection features 217. As shown, the buttresses 230 may be secured to the joint members with bars or rods 217 that extend from a buttress 230 on a top side of the joint to a buttress 230 on a bottom side of the joint. In other examples, the buttresses 230 on the top may be isolated from the buttresses 230 on the bottom and each buttress 230 may be secured to the joint members with a bolt extending through the flange 212A/B and the channel 216. The bars or rods shown, which couple to the upper and lower buttresses 230 may be helpful to stabilize the buttresses 230 and hold them square or orthogonal to the surface of the flanges 212A/212B of the I-shaped member 215.

With the parts of the secondary energy absorption system 204 for this example described, an approach different from above for the tension inducing coupling system may also be described. That is, the mechanism that this example uses to place the tie or ties 210 in tension whether the joint experiences tensile or compressive forces may be slightly different. As shown in FIG. 8, this functionality may be provided by securing the buttresses 230 at each end of the joint to the first and second portions 200A/B of the damping mechanism 200 using slotted holes 219. That is, for example, slotted holes 219 may be provided in the flange 212A/B of the I-shaped member 215 and the flanges of the channel 216. The mentioned bolt, rod, or bar 217 may extend from the buttress 230 through the slotted hole 219 to secure the buttress 230 to both the I-shaped member 215 and the channel 216. The slotted holes 219 may be provided at each end of the joint for each of the buttresses 230. Moreover, the ties 210 may be tightened or coupled between the buttresses 230 to draw the bolt, rod, or bar 217 inward toward the joint to abut an inboard edge of the slotted holes 219.

With continued reference to FIG. 8, when the joint experiences tension (e.g., the I-shaped member 215 is moving to the right and the channels 216 are moving to the left or staying stationary or the channels 216 are moving the left and the I-shaped member 215 is staying stationary), the slotted hole 219 in the I-shaped member 215 at the right side of the joint may engage the rod 217 of the buttress 230 on the right and may urge the buttress 230 further to the right. However, the slotted hole 219 in the I-shaped member 215 at the left side of the joint may move along the rod 217 of the buttress 230 on the left allowing the buttress 230 to remain stationary or at least avoid moving with the I-shaped member 215. Meanwhile, the slotted hole 219 in the channel 216 on the left side of the joint may engage the rod 217 of the buttress 230 on the left and may urge the buttress 230 further to the left or hold it stationary as the case may be. However, the slotted hole 219 in the channel 216 at the right side of the joint may move along the rod 217 of the buttress 230 or allow the rod to move along the slot 219 thereby avoiding restricting the movement of the right buttress 230. The motion of the right buttress 230 away from the left buttress 230 may stretch the ties 210 thereby supplementing the frictional resistance of the primary energy absorption system. The opposite may be true when the joint experiences compression. That is, leftward motion of the I-shaped member 215 may induce motion of the left buttress 230 to the left, but may allow the right buttress 230 to be held in place by the channel 216, thereby stretching the ties 210 and supplementing the frictional resistance of the primary energy absorption system.

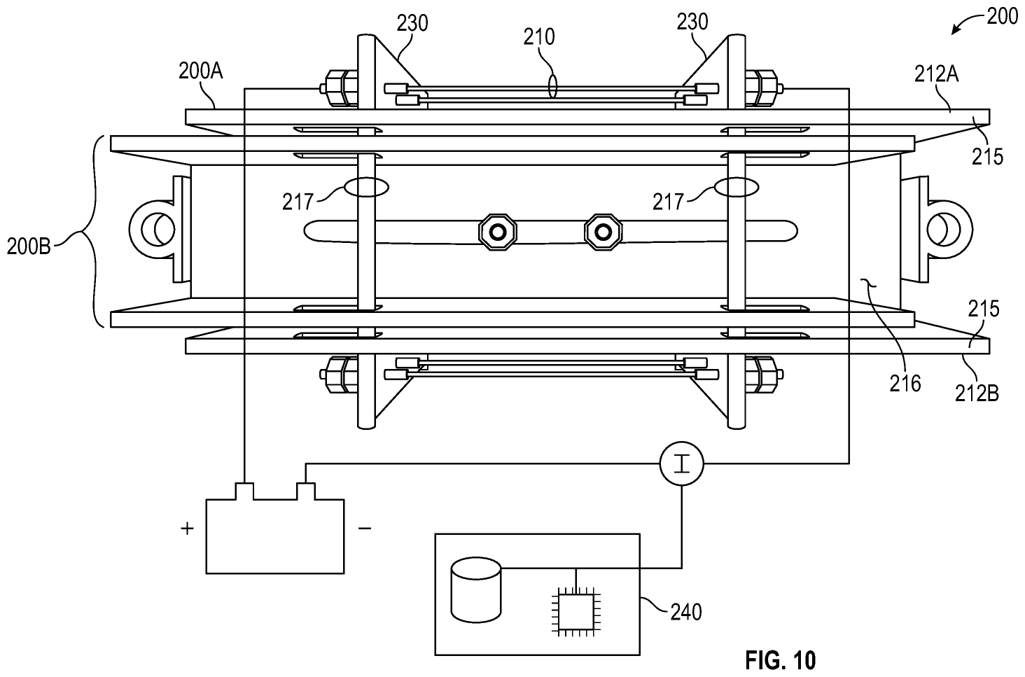

It may be appreciated that the electrical resistance of the ties 210 may change as they deform in a non-linear fashion. Accordingly, in one or more embodiments, electrical current may be provided through the ties 110/210 allowing the strain in the ties 110/210 to be assessed from time to time and help to assess the damping mechanism 100/200 and/or the forces being experienced by the building. For example, the current may be correlated to a maximum strain and if the strain exceeds the maximum strain, based on the electrical current, further steps may be taken to further investigate the situation. For example, the further investigation may include collecting strain details to begin to understand the maximum displacements in the building or other structure. As shown in FIG. 10, in one or more embodiments, a computing device 240 may be provided that may monitor the strains in one or more devices throughout the building and based on electrical currents in the ties 110/210 of one or more damping devices 100/200. This system may allow for assessing the damping devices 100/200 and/or the entire structure without opening up walls or otherwise physically accessing the braces 101 and/or the damping devices 100/200 in the braces 101 of the building or other structure.

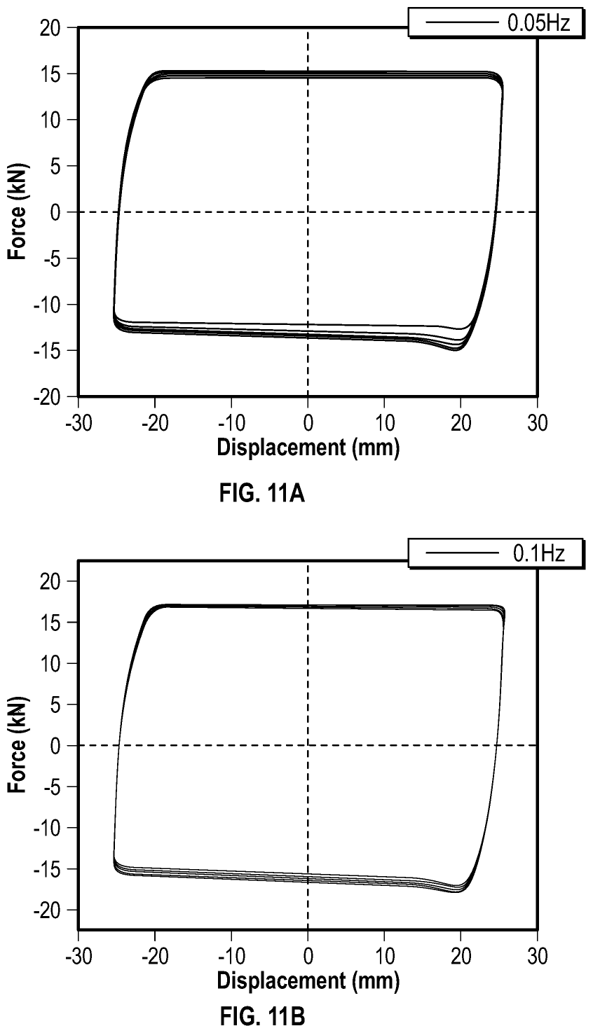

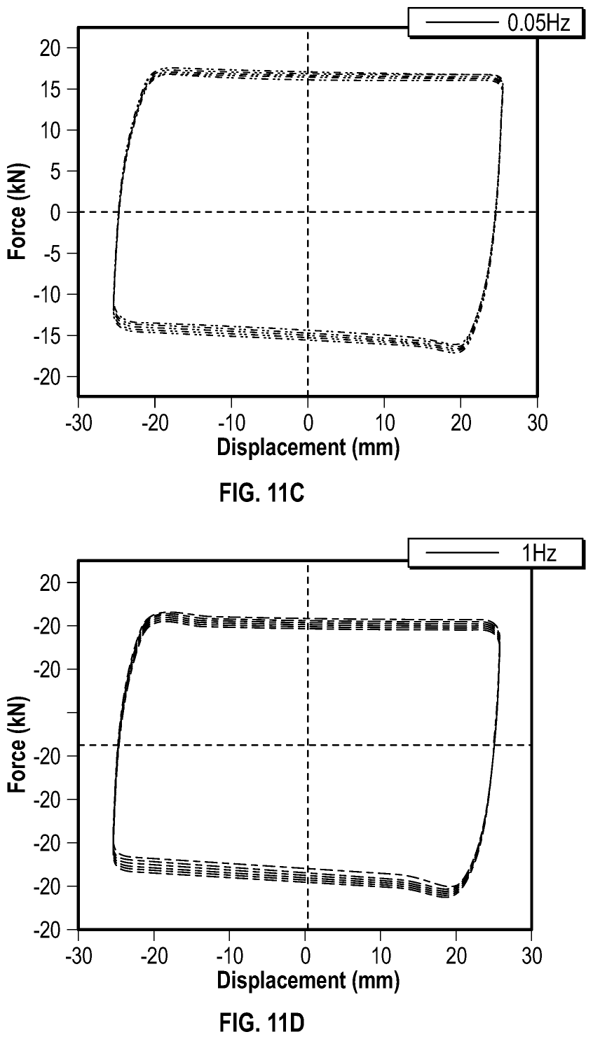

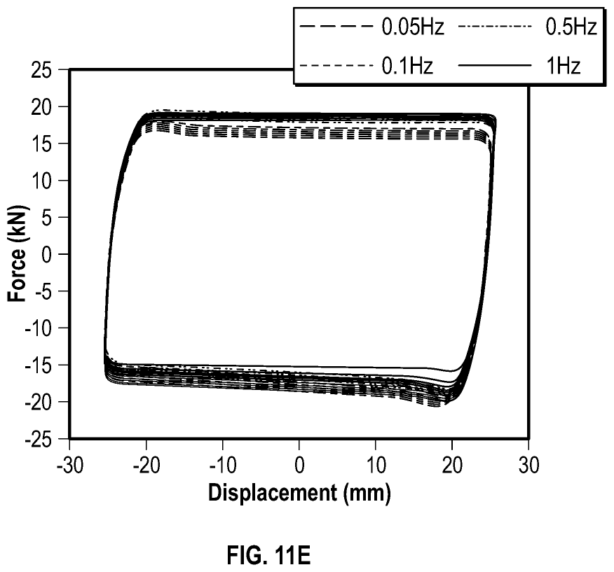

FIGS. 11A-11E show hysteresis curves for a cyclic loading applied at varying frequencies for a damping mechanism. The damping mechanism used to generate these FIGS. included only a primary energy absorption system 102 and, in particular, a friction damper such as the one described herein. As shown, over a range of frequencies including 0.05 Hz, 0.1 Hz, 0.5 Hz, and 1 Hz, a relatively rectangular hysteresis curve occurs. This may be as expected, since the normal force imposed on the system may be based on the torque in the bolts holding the channels to the I-shaped member and, as such, the frictional resistance generated by the primary energy dissipation system may be substantially constant. As shown, for example in FIG. 11A, as the damping device moves through cycles from fully extended (e.g., 20 mm) to fully compressed (e.g., −20 mm), the force generated within the damping device may be a relatively constant 15 kN or −15 kN as the case may be. This may be true across all of the frequencies tested. Moreover, the relatively consistent and repeating rectangular curves may suggest that little to no degradation of the joint or the energy absorption is occurring. However, there is also no evidence of a self-centering component.

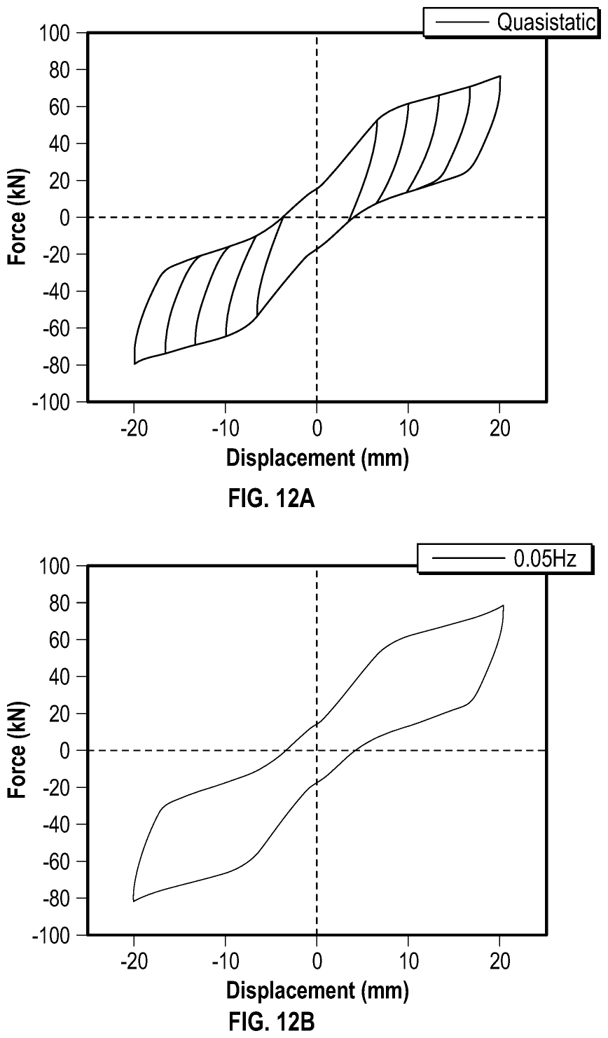

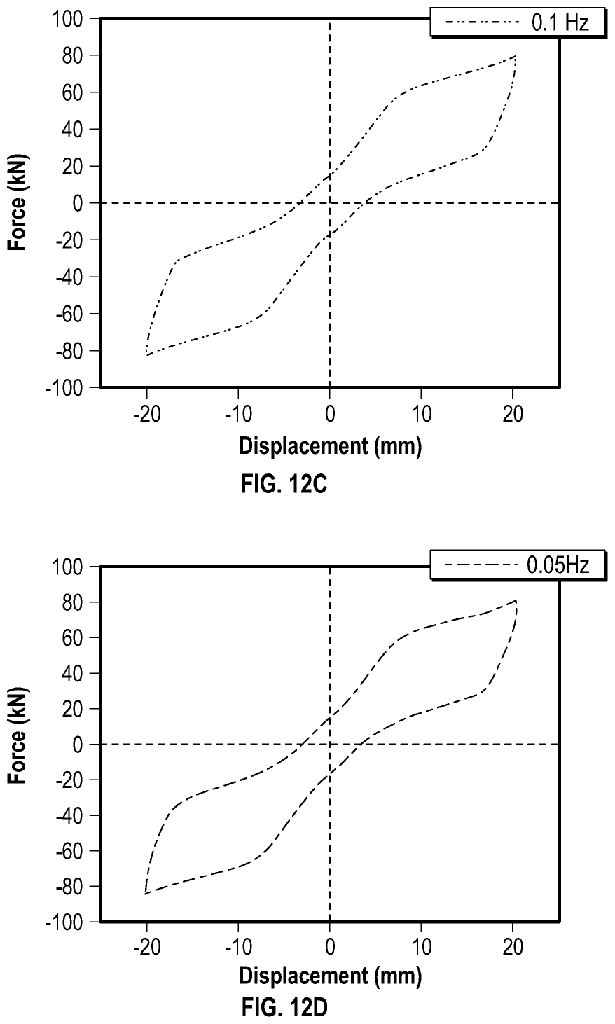

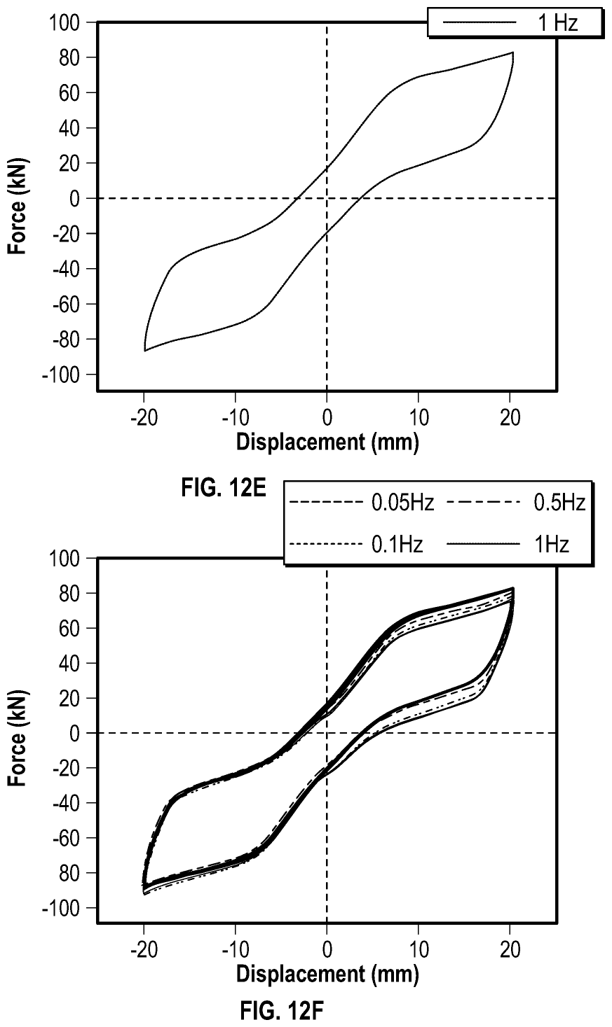

In contrast, when reviewing FIGS. 12A-12F, a similar set of hysteresis curves are shown for a cyclic loading applied at varying frequencies for a damping mechanism 100/200 such as the ones described herein that includes a primary energy absorption system 102 in the form of a friction-based damping system and also includes a secondary energy absorption system 104 in the form of shape memory alloys, and, in particular, super elastic alloys. As shown in FIG. 12A, the damping mechanism 100/200 exhibits a stable behavior when it is loaded at different displacement amplitudes. As shown in FIGS. 12B-12F, a longer and more slender hysteresis loop is generated as compared to FIGS. 11A-11E. However, like FIGS. 11A-11E, the loops are consistent over repeated cycles and do not vary from cycle to cycle suggesting that little to no degradation of the joint or either energy absorption system is occurring. That said, the displacements in the system tends to approach zero as the force of the system approaches zero. This effect on the hysteresis curve stems from the fact that the ties have the ability to return to their original position as the system oscillates between a tensile condition and a compressive condition. Rather, as the system experiences tensile loading, the load is resisted by the primary (friction) and secondary (SMA) systems, but when the joint reaches is furthest displacement and begins returning to a neutral position, the secondary system (e.g., the ties) recover their deformations and when the joint begins the compressive side of the cycle, the ties are again tensioned until the joint reaches its further displacement in that direction and the cycle continues. As such, the hysteresis curve makes it evident that the secondary energy absorption system is functioning to absorb energy without having any permanent or residual deformations. Moreover, and consequently, the secondary system provides a self-centering function by limiting motion that diverges from a neutral position.

In operation and use, the damping device may be used to resist wind and/or seismic forces on a building. For example, a method of use may include installing the damping mechanism in a brace by bolting, welding, or otherwise securing a first portion of the damping mechanism to a first portion of a brace and securing a second portion of the damping mechanism to a second portion of a brace. Alternatively, the first and second portions of the damping mechanism may be part and parcel to the first and second portions of the brace either by way of being installed earlier or by the brace manufacturer or by be part of the fabrication process of the brace. The method may also include damping lateral loads to a structure by resisting the loads with a primary energy absorption system and, further by resisting loads with a secondary energy absorption system. As described above, the primary energy absorption system may include frictional damping system and the secondary energy absorption system may include a shape memory alloy and, in particular, a super elastic alloy. The damping device may operate to absorb energy from lateral loads and may also perform a centering function for the damping mechanism.

The above detailed description is intended to be illustrative, and not restrictive. The scope of the disclosure should, therefore, be determined with references to the appended claims, along with the full scope of equivalents to which such claims are entitled.

What is claimed is:

1. A damping mechanism for damping energy resulting from a lateral force on a structure, comprising:
a first portion;
a second portion configured for longitudinal motion relative to the first portion;
a primary energy absorption system configured for frictionally coupling the first portion and the second portion and converting motion of the second portion relative to the first portion into heat energy; and
a secondary energy absorption system configured to absorb energy through non-linear deformation and provide a self-centering effect on the damping mechanism.

2. The mechanism of claim 1, wherein the secondary energy absorption system comprises a shape memory alloy.

3. The mechanism of claim 2, wherein the shape memory alloy is a super elastic alloy.

4. The mechanism of claim 1, wherein the secondary energy absorption system comprises a tie and is configured to place the tie in tension both when the energy is a tensile force and when the energy is a compression force.

5. The mechanism of claim 4, wherein the secondary energy absorption system comprises first and second end buttresses spaced apart from one another and secured to one another with the tie.

6. The mechanism of claim 5, wherein aside from the presence of the tie, the first and second end plates are free to move away from the frictional coupling.

7. The mechanism of claim 1, wherein the primary energy absorption system comprises a friction pad between the first portion and the second portion and a fastener passing through the first portion and the second portion and establishing a normal force.

8. The mechanism of claim 7, wherein the first portion or the second portion comprise a slotted hole for movement of the fastener along the respective first or second portion.

9. The mechanism of claim 1, wherein the second portion has an I-shaped cross-section with two flanges and a web extending orthogonally between the flanges.

10. The mechanism of claim 9, wherein the second portion comprises a slotted hole in the web.

11. The mechanism of claim 10, wherein the first portion comprises a pair of channels arranged on each side of the web

12. The mechanism of claim 11, wherein the primary energy absorption system comprises a bolt passing through the pair of channels and the slotted hole and a friction pad arranged on each side of the web between each channel and the web.

13. The mechanism of claim 12, wherein the friction pad comprises a non-metallic molded strip.

14. A structural frame for a building or other structure, comprising:
a plurality of columns each having a bottom end and a top end;
a brace arranged to laterally stabilize the frame; and
a damping mechanism associated with the frame for damping energy resulting from a lateral force on the structural frame, the mechanism comprising:
a first portion;
a second portion configured for longitudinal motion relative to the first portion;
a primary energy absorption system configured for frictionally coupling the first portion and the second portion and converting motion of the second portion relative to the first portion into heat energy; and
a secondary energy absorption system configured to absorb energy through non-linear deformation and provide a self-centering effect on the damping mechanism.

15. The frame of claim 14, wherein the secondary energy absorption system comprises a shape memory alloy.

16. The frame of claim 15, wherein the shape memory alloy is a super elastic alloy.

17. The frame of claim 16, wherein the secondary energy absorption system comprises a tie and is configured to place the tie in tension both when the energy is a tensile force and when the energy is a compression force.

18. The frame of claim 17, wherein the secondary energy absorption system comprises first and second end buttresses spaced apart from one another and secured to one another with the tie.

19. The frame of claim 14, wherein the primary energy absorption system comprises a friction pad between the first portion and the second portion and a fastener passing through the first portion and the second portion and establishing a normal force.

20. The frame of claim 19, wherein the first portion or the second portion comprise a slotted hole for movement of the fastener along the respective first or second portion.
